(19) United States
(12) Patent Application Publication
(10) Pub. No.: US 2011/0107261 A1
(43) Pub. Date: May 5, 2011

(54) ELECTRONIC DEVICE AND METHOD THEREOF FOR MANAGING APPLICATION MENU STRUCTURE

(75) Inventors: WEI-TE LIN, Tu-Cheng (TW); TE-HUA LEE, Tu-Cheng (TW)

(73) Assignee: HON HAI PRECISION INDUSTRY CO., LTD., Tu-Cheng (TW)

(21) Appl. No.: 12/837,428

(22) Filed: Jul. 15, 2010

(30) Foreign Application Priority Data
Nov. 4, 2009 (CN) 200910309278.6

(51) Int. Cl. G06F 3/048

(52) U.S. Cl. 715/811; 715/841; 715/834

(57) ABSTRACT

The disclosure relates to an electronic device and a method thereof for managing an application menu structure. The application menu structure includes a main menu having a list of main options. The electronic device includes a display module, a calculation module, and a display module. The calculation module calculates usage frequency of each of the main options. The disposition module disposes one of the main options having greatest usage frequency at the center of the display module and disposes another one of the main options having a non-greatest usage frequency to surround the one of the main options of the greatest frequency on the display module.

### BACKGROUND

1. Technical Field

The present disclosure relates to an electronic device and a method thereof for managing an application menu structure.

2. Description of Related Art

Different electronic devices may have different user interfaces according to requirements. User interfaces usually include an application menu structure having a main menu and a list of sub-menus. The menu and the sub-menus may extend to several pages, and therefore main options of the main menu and sub-options of the sub-menus are distributed over the pages. It is inconvenient for users to select desired options to operate from the application menu structure.

Accordingly, an improved electronic device and method are called for in order to overcome the limitations described.

### BRIEF DESCRIPTION OF THE DRAWINGS

FIG. 1 is a block diagram of one embodiment of an electronic device.

FIG. 2 shows an exemplary embodiment of a main menu of an electronic device.

FIG. 3 shows an exemplary embodiment of a sub-menu of an electronic device.

FIGS. 4A-4B shows exemplary embodiments of operating of a main menu.

FIG. 5 is a flowchart illustrating one embodiment of a method for managing an application menu structure of an electronic device.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

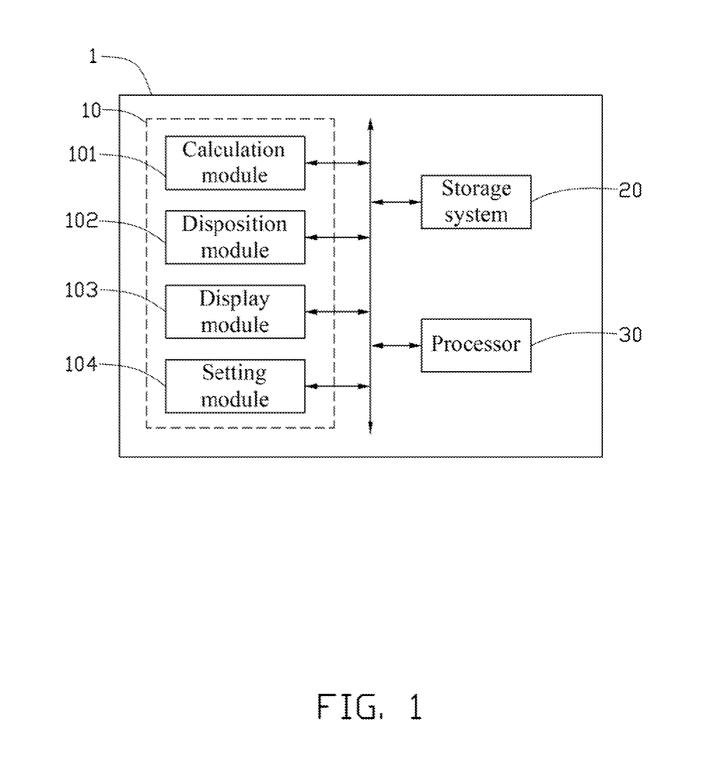

FIG. 1 is a block diagram of one embodiment of an electronic device 1 comprising a system 10. The electronic device may be a mobile phone, a personal digital assistant (PDA), a digital still camera (DSC), or other portable device, for example. The system 10 includes a calculation module 101, a disposition module 102, a display module 103, and a setting module 104. The electronic device 1 further includes a storage system 20, and a processor 30. The processor 30 may execute one or more programs stored in the storage system 20 to provide functions for the calculation module 101, the disposition module 102, a display module 103, and the setting module 104.

The electronic device 1 is generally controlled and coordinated by an operating system, such as UNIX, Linux, Windows, Mac OS, an embedded operating system, or any other compatible system. Alternatively, electronic device 1 may be controlled by a proprietary operating system. Typical operating systems control and schedule computer processes for execution, perform memory management, provide file system, networking, and I/O services, and provide a user interface, such as a graphical user interface (GUI), among other tasks.

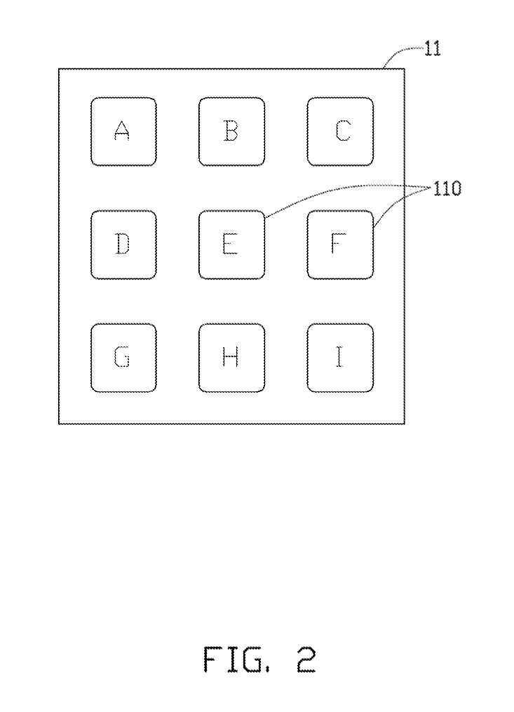

FIG. 2 shows an exemplary embodiment of a main menu 11 displayed on the display module 103 of the electronic device 1. The main menu 11 includes a list of main options 110. The main options 110 may include applications, settings of the electronic device, file folders, and information. The storage system 20 stores an application menu structure including the main menu 11. The display module 103 may be a screen, such as an LCD screen, for example.

The calculation module 101 is operable to calculate usage frequency of each of the main options 110. The disposition module 102 is operable to dispose one of the main options 110 having greatest usage frequency at the center of the display module 103 under the main menu 11, and dispose another one of the main options 110 having a non-greatest usage frequency to surround the one of the main options 110 having the greatest usage frequency on the display module under the main menu. The main options 110 may be represented with icons. In such an example, with reference to FIG. 2, an icon “E” is the one of the main options 110 having the greatest usage frequency, and icons “A”˜“I” other than “E” are the ones of the main options 110 having the non-greatest usage frequency. In the embodiment, the icons “A”˜“I” other than “E” are ones of the main options 110 having the secondary usage frequency. However, it should be understood that the main menu options 110 can be arranged in other ways according to usage frequency depending on the embodiment.

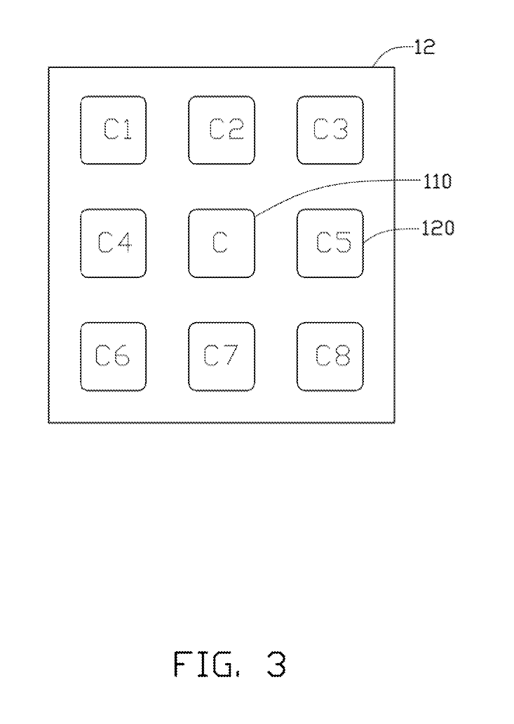

FIG. 3 shows an exemplary embodiment of a sub-menu 12 of an electronic device 1. In the embodiment, a icon “C” is operated so that the display module 103 displays the sub-menu 12 corresponding to the icon “C”. The setting module 104 is operable to set the icon “C” as a reverse option for reversing the sub-menu 12 to the main menu 11.

The sub-menu 12 includes a list of sub-options 120. The sub-options 120 may include applications, settings of the electronic device, file folders, and information. The calculation module 101 further calculates usage frequency of each of the sub-options 120, so that the disposition module 102 disposes one of the sub-options 120 having a greater usage frequency to surround the icon “C” on the display module 103. In the embodiment, the sub-options 120 may be represented with the icons. Icons “C1”˜“C8” are the ones of sub-options 120 having the greater usage frequency.

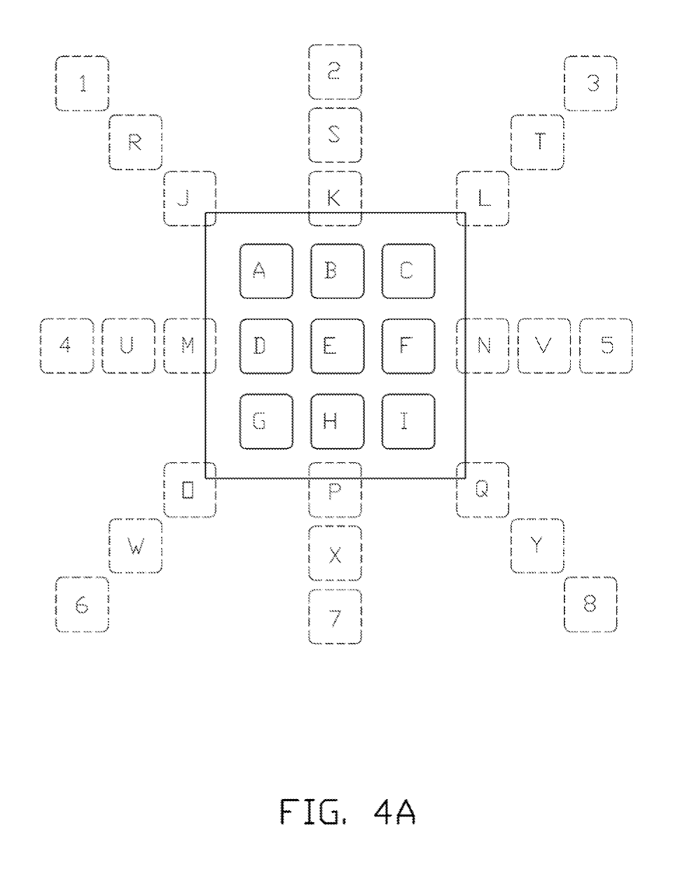

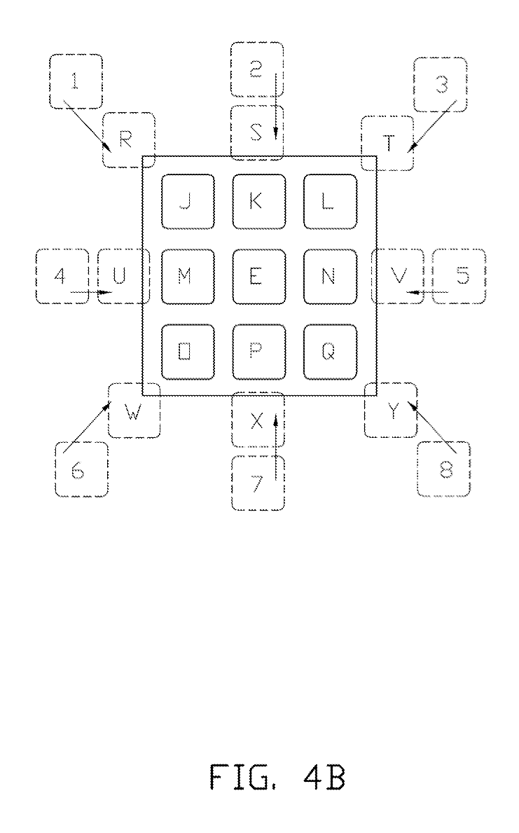

FIGS. 4A-4B shows exemplary embodiments of operating of the main menu 11. In the embodiments, the one of the main options having the non-greatest usage frequency radially surrounds the one of the main options 110 having the greatest usage frequency on the display module 103. Particularly, the icons “A”˜“I” other than “E” radially surround the icon “E” and icons “J”˜“Q” radially surround the icons “A”˜“I” other than “E”. The usage frequency of each of the icons “A”˜“I” other than “E” is greater than that of each of the icons “J”˜“Q”. Similarly, the icons “C1”˜“C8” radially surround the icon “C” on the display module 103 under the sub-menu 12. Only the icons “A”˜“I” are simultaneously displayed on the display module 103 due to the size of the display module 103. The electronic device further provides two functions “page down” and “page up” to operate the application menu structure. When the function “page down” is operated, the disposition module 102 maintains the icon “E” at the center of the display module 103, and disposes the icons “J”˜“Q” rather than the icons “A”˜“I” other than “E” to radially surround the icon “E”. When the icons “J”˜“Q” radially surround the icon “E” and the function “page up” is operated, the disposition module 102 disposes the icons “A”˜“I” other than “E” rather than the icons “J”˜“Q” to radially surround the icon “E”.

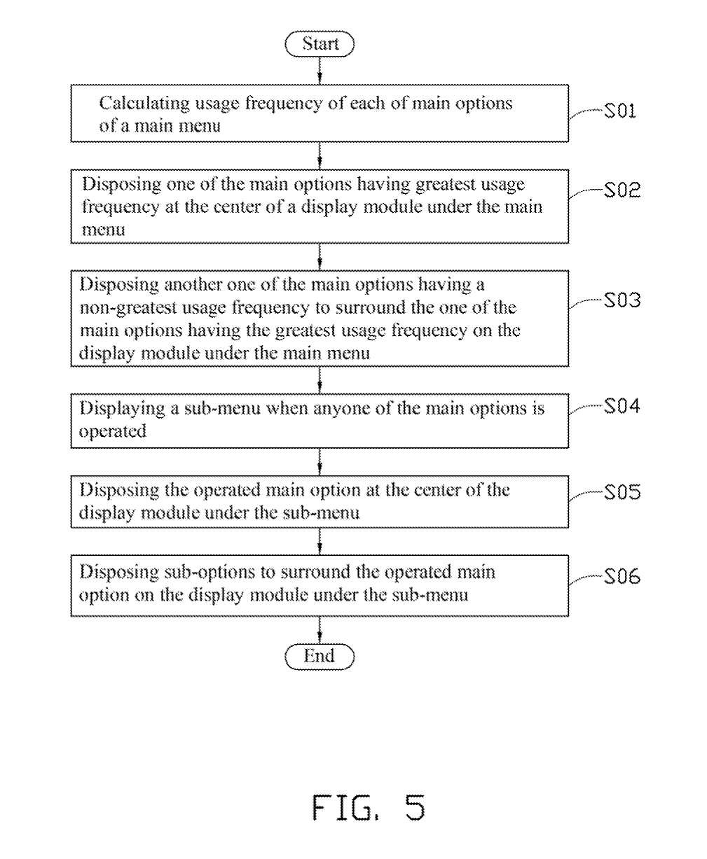

FIG. 5 is a flowchart illustrating one embodiment of a method for managing an application menu structure of the electronic device 1. Depending in the embodiment, additional blocks in the flow of FIG. 5 may be added, others removed, and the ordering of the blocks may be changed.

In block S01, the calculation module 101 calculates the usage frequency of each of the main options 110 of the main menu 11.

In block S02, the disposition module 102 disposes the one of the main options 110 having the greatest usage frequency at the center of the display module 103 under the main menu 11.

In block S03, the disposition module 102 disposes the one of the main options 110 having the non-greatest usage frequency to surround the one of the main option 110 having the greatest usage frequency on the display module 103 under the main menu 11.

In block S04, the display module 103 displays the sub-menu 12 when the one of the main options 110 is operated.

In block S05, the disposition module 102 disposes the operated main option 110 at the center of the display module 103 under the sub-menu 12.

In block S06, the disposition module 102 disposes the sub-options 120 to surround the operated main option 110 on the display module 103 under the sub-menu 12.

The present disclosure provides an electronic device and a method thereof for managing an application menu structure and increasing convenience of use thereof.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for managing an application menu structure of an electronic device, the application menu structure comprising a main menu displayed on a display module of the electronic device, the main menu comprising a list of main options, the method comprising:
calculating usage frequency of each of the main options;
disposing one of the main options having greatest usage frequency at the center of the display module under the main menu; and
disposing another one of the main options having a non-greatest usage frequency to surround the one of the main options on the display module under the main menu.

2. The method of claim 1, further comprising:
displaying a sub-menu when anyone of the main options is operated;
disposing the operated main option at the center of the display module under the sub-menu; and
setting the operated main option as a reverse option for reversing the sub-menu to the main menu.

3. The method of claim 2, wherein the sub-menu comprises a list of sub-options, the method further comprising:
disposing the sub-options to surround the operated main option on the display module under the sub-menu.

4. The method of claim 3 further comprising:
calculating usage frequency of each of the sub-options; and
disposing one of the sub-options having a greater usage frequency to surround the operated main option on the display module under the sub-menu.

5. The method of claim 1, wherein the one of the main options having the non-greatest usage frequency radially surrounds the one of the main options having the greatest usage frequency on the display module under the main menu.

6. The method of claim 4, wherein the one of the sub-options having the greater usage frequency radially surround the operated main option on the display module under the sub-menu.

7. An electronic device, comprising:
a storage system;
at least one processor;
one or more programs stored in the storage system and being executable by the at least one processor;
an application menu structure stored in the storage system, comprising a main menu displayed on a display module, wherein the main menu comprises a list of main options;
a display module operable to display the main menu;
a calculation module operable to calculate usage frequency of each of the main options; and
a disposition module operable to dispose one of the main options having greatest usage frequency at the center of the display module under the main menu, and dispose another one of the main options having a non-greatest usage frequency to surround the one of the main options having the greatest usage frequency on the display module under the main menu.

8. The electronic device of claim 7, wherein the display module is further operable to display a sub-menu corresponding to anyone of the main options operated, and the sub-menu comprises a list of sub-options.

9. The electronic device of claim 8, further comprises a setting module operable to set the operated main option as a reverse option for reversing the sub-menu to the main menu.

10. The electronic device of claim 9, wherein the calculation module further calculates usage frequency of each of the sub-options, and the disposition module disposes one of the sub-options having a greater usage frequency to surround the operated main option on the display module.

11. The electronic device of claim 7, wherein the one of the main options having the non-greatest usage frequency radially surrounds the one of the main options having the greatest usage frequency on the display module.

12. The electronic device of claim 10, wherein the one of the sub-options having the greater usage frequency radially surround the operated main option on the display module under the sub-menu.

13. A storage medium having stored thereon instructions that, when executed by a processor, cause the processor to perform a method for managing an application menu structure of an electronic device, the application menu structure comprises a main menu displayed on a display module of the electronic device, the main menu comprising a list of main options, the method comprises:
calculate usage frequency of each of the main options;
dispose one of the main options having greatest usage frequency at the center of the display module under the main menu; and
dispose another one of the main options having a non-greatest usage frequency to surround the one of the main options having the greatest usage frequency on the display module under the main menu.

14. The storage medium of claim 13, wherein the method further comprises:
display a sub-menu when anyone of the main options is operated;
dispose the operated main option at the center of the display module under the sub-menu; and
set the operated main option as a reverse option for reversing the sub-menu to the main menu.

15. The storage medium of claim 14, wherein the sub-menu comprises a list of sub-options, the method further comprises:
dispose the sub-options to surround the operated main option on the display module under the sub-menu.

16. The storage medium of claim 15, wherein the method further comprises:
calculate usage frequency of each of the sub-options; and
dispose one of the sub-options having a greater usage frequency to surround the operated main option on the display module under the sub-menu.

17. The storage medium of claim 13, wherein the one of the main options having the non-greatest usage frequency radially surrounds the one of the main options having the greatest usage frequency on the display module under the main menu.

18. The storage medium of claim 16, wherein the one of the sub-options having the greater usage frequency radially surround the operated main option on the display module under the sub-menu.
